(19) United States
(12) Patent Application Publication
(10) Pub. No.: US 2014/0247492 A1
(43) Pub. Date: Sep. 4, 2014

(54) DIFFRACTION OPTICAL ELEMENT, OPTICAL SYSTEM, AND OPTICAL APPARATUS

(71) Applicant: CANON KABUSHIKI KAISHA, Tokyo (JP)

(72) Inventor: Reona Ushigome, Saitama-shi (JP)

(73) Assignee: CANON KABUSHIKI KAISHA, Tokyo (JP)

(21) Appl. No.: 14/195,685

(22) Filed: Mar. 3, 2014

(30) Foreign Application Priority Data
Mar. 4, 2013 (JP) 2013-041781

(51) Int. Cl. G02B 5/18

(52) U.S. Cl. CPC G02B 5/1866
USPC 359/569

(57) ABSTRACT

A diffraction optical element including: a diffractive grating provided with a grating surface and a grating wall surface; and a thin film arranged on the grating wall surface and being transparent with respect to light of a used wavelength range, wherein
the following expressions;

0.05<nfd−ngd<0.5

0.01<(nfd−ngd)*wf/λd<0.05

are satisfied,
where nfd is a refractive index of the thin film with respect to a d line, ngd is a refractive index of a material of the diffractive grating with respect to the d line, wf is a thickness of the thin film, and λd is a wavelength of the d line.

### BACKGROUND OF THE INVENTION

1. Field of the Invention

This disclosure relates to a diffraction optical element, an optical system, and an optical apparatus.

2. Description of the Related Art

A technology in which two refractive gratings are arranged in closely contact with each other, and a material which constitutes the respective diffractive gratings and the height of the grating are set adequately to obtain a high diffraction efficiency in a wide wavelength band is known. When an optical flux enters the diffraction optical element provided with grating surfaces and grating wall surfaces, unnecessary light (flare) is generated due to the influence of the grating wall surfaces even though the diffraction optical element has an optical configuration calculated on the basis of a scalar diffraction theory.

US2009/0231712 discloses a diffraction optical element improved in diffraction efficiency of a designed order by using a Rigorous Coupled Wave Analysis (RCWA). US2011/0304918 discloses a diffraction optical element used in a lens of an optical system configured to reduce unnecessary light that reaches an imaging surface from unnecessary light generated by an optical flux incident at an inclined incident angle (out-of screen light incident angle).

The diffraction optical element disclosed in US2009/0231712 is configured to improve a diffraction efficiency of a designed order by defining a relationship of refractive indexes and Abbe numbers of materials which constitute two diffractive gratings. However, US2009/0231712 does not disclose an improvement of the diffraction efficiency without changing the materials of the diffractive gratings by controlling the structure of the element in the vicinity of the grating wall surfaces.

The diffraction optical element disclosed in US2011/0304918 lets light go out by using the optical flux incident at the inclined incident angle to reduce the unnecessary light that reaches the imaging surface. However, a technology to improve the diffraction efficiency of the optical flux having the designed order and incident at a designed incident angle and reduce the diffraction efficiencies of one order higher and lower the designed order is not disclosed.

### SUMMARY OF THE INVENTION

This disclosure provides a diffraction optical element, an optical system, and an optical apparatus configured to improve a diffraction efficiency of a designed order of an optical flux incident at a designed incident angle, reduce the diffraction efficiency of diffracted light beams of one order higher and lower the designed order, and reduce unnecessary light that enters at an inclined incident angle (out-of screen light incident angle) and reaches an imaging surface.

This disclosure provides a diffraction optical element including: a diffractive grating provided with a grating surface and a grating wall surface; and a thin film arranged on the grating wall surface and being transparent with respect to light of a used wavelength range, wherein the following expressions;

0.05<nfd−ngd<0.5

0.01<(nfd−ngd)*wf/λd<0.05

are satisfied, where nfd is a refractive index of the thin film with respect to a d line, ngd is a refractive index of a material of the diffractive grating with respect to the d line, wf is a thickness of the thin film, and λd is a wavelength of the d line.

Further features of the present invention will become apparent from the following description of exemplary embodiments with reference to the attached drawings.

### BRIEF DESCRIPTION OF THE DRAWINGS

FIG. 1A is a plan view and a side view of a diffraction optical element according to an embodiment of this disclosure, FIG. 1B is a partially enlarged perspective view of a diffractive grating portion, and FIG. 1C is a partially enlarged cross-sectional view of the diffractive grating portion.

FIG. 2 is a detailed drawing illustrating an optical system and an optical apparatus having the diffraction optical element of the embodiment of this disclosure.

FIG. 3 is a partially enlarged cross-sectional view illustrating an optical system having the diffraction optical element of the embodiment of this disclosure.

FIG. 4 is a schematic drawing for explaining an influence of unnecessary light at a designed incident angle (incident angle of image taking light) in the optical system having the diffraction optical element of the embodiment of this disclosure.

FIG. 5A and FIG. 5B are graphs of diffraction efficiency of the diffraction optical element of Example 1 with respect to an optical flux at the designed incident angle.

FIG. 6A and FIG. 6B are graphs of diffraction efficiency of the diffraction optical element of Comparative Example 1 with respect to an optical flux at the designed incident angle.

FIG. 7 is a schematic drawing for explaining an influence of unnecessary light at an inclined incident angle (out-of screen light incident angle) in the optical system having the diffraction optical element of the embodiment of this disclosure.

FIG. 8A and FIG. 8B are graphs of diffraction efficiency of the diffraction optical element of Example 1 with respect to an optical flux at an out-of screen light incident angle of +10°.

FIG. 9A and FIG. 9B are graphs of diffraction efficiency of the diffraction optical element of Comparative Example with respect to the optical flux at an out-of-screen incident angle of +10°.

FIG. 10A and FIG. 10B are graphs of diffraction efficiency of the diffraction optical element of Example 1 with respect to an optical flux at an out-of-screen incident angle of −10°.

FIG. 11A and FIG. 11B are graphs of diffraction efficiency of the diffraction optical element of Comparative Example with respect to an optical flux at an out-of-screen incident angle of −10°.

FIG. 12A and FIG. 12B are graphs of diffraction efficiency of the diffraction optical element of Example 2 with respect to optical fluxes at the designed incident angle and the out-of-screen incident angle.

FIG. 13A and FIG. 13B are graphs of diffraction efficiency of the diffraction optical element of Example 3 with respect to optical fluxes at the designed incident angle and the out-of-screen incident angle.

FIG. 14A and FIG. 14B are graphs of diffraction efficiency of the diffraction optical element of Example 4 with respect to optical fluxes at the designed incident angle and the out-of-screen incident angle.

FIG. 15A and FIG. 15B are graphs of diffraction efficiency of the diffraction optical element of Example 5 with respect to optical fluxes at the designed incident angle and the out-of-screen incident angle.

FIG. 16A and FIG. 16B are graphs of diffraction efficiency of the diffraction optical element of Example 6 with respect to optical fluxes at the designed incident angle and the out-of-screen incident angle.

FIG. 17A and FIG. 17B are graphs of diffraction efficiency of the diffraction optical element of Comparative Example with respect to optical fluxes at the designed incident angle and the out-of-screen incident angle.

FIG. 18 is a partially enlarged perspective view of the diffractive grating portion according to a second embodiment of this disclosure.

FIG. 19 is a partially enlarged perspective view of the diffractive grating portion according to a third embodiment of this disclosure.

### DESCRIPTION OF THE EMBODIMENTS

### First Embodiment

### Optical System and Optical Apparatus

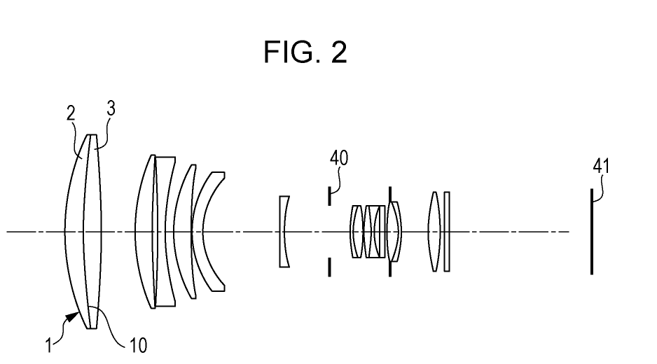

FIG. 2 is a detailed drawing illustrating an optical system and an optical apparatus having a diffraction optical element (DOE) 1 of an embodiment of this disclosure. In other words, the image-taking optical system of a telephoto-type provided with a diffractive surface on a second surface is applied to an image taking apparatus (camera or the like) as an optical system. In FIG. 2, reference numeral 30 denotes an image-forming lens and includes an aperture 40 and the DOE 1 in the interior thereof. The aperture 40 is arranged on the rear side of the DOE 1. Reference numeral 41 denotes an imaging surface, on which film or a photoelectric conversion element such as a CCD or a CMOS is arranged. A center of gravity of a distribution of incident angles of optical fluxes entering a diffractive grating portion 10 (the same as the center of gravity of a graphic) is set to be distributed near a center of the diffractive grating portion 10 with respect to a surface normal at the center of the diffractive grating on an enveloping surface.

When the diffraction optical element is applied to the optical system configured as described above, unnecessary light of the image-taking light is reduced, and unnecessary light reaching the imaging surface when the optical flux enters from the out-of-screen is reduced, so that an image-forming lens with less flare is obtained.

Although the DOE 1 is provided on a bonding surface of a lens closest to an object in the first embodiment. However, this disclosure is not limited thereto, and may be provided on a surface of the lens or a plurality of the diffraction optical elements may be provided in the image-forming lens. The optical system to which the DOE 1 is applicable is not limited to the image-taking optical system illustrated in FIG. 2, and may be image-forming lenses for video cameras, image scanners, imaging optical systems used in wide wavelength ranges such as leader lenses used in copying machines, observing optical system such as binoculars or telescopes, or optical finders. Also, apparatuses to which the optical system including the DOE 1 is applicable are not limited to image-taking apparatuses, and may be an optical apparatus in a broad sense.

### Diffraction Optical Element

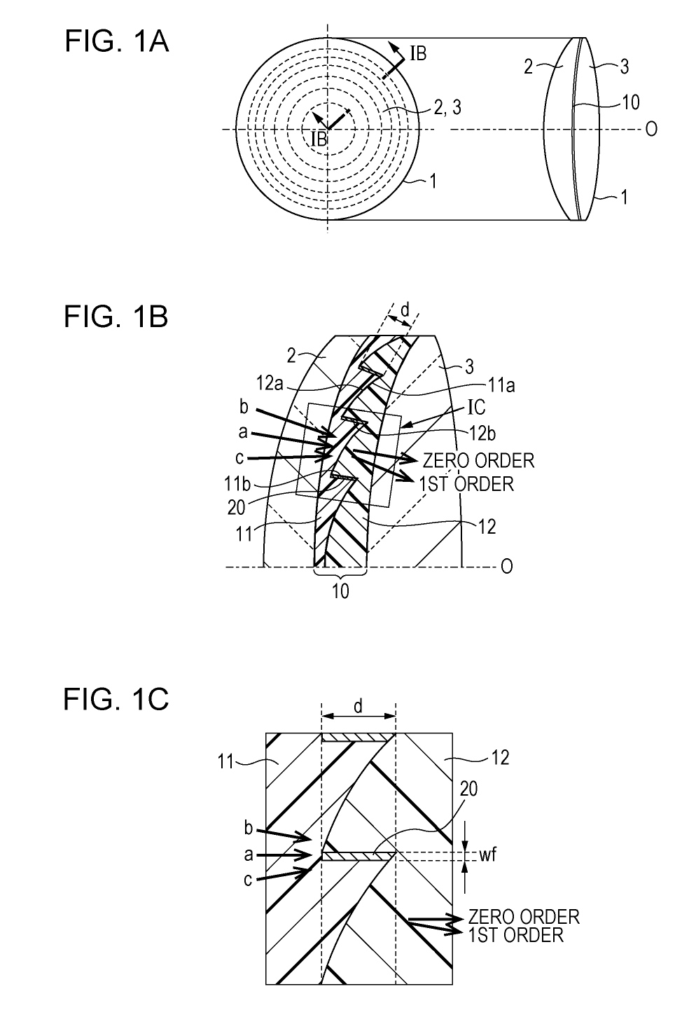

FIG. 1A is a plan view and a side view of the diffraction optical element (DOE) 1 according to the first embodiment. The DOE 1 is configured to improve the diffraction efficiency of a diffracted light beam of one specific order (hereinafter, referred to as “specific order” or “designed order”) in a used wavelength range of a visible wavelength band. The DOE 1 includes a transparent pair of substrates 2 and 3, and the diffractive grating portion 10 arranged therebetween. The respective substrates 2 and 3 have a flat plate shape or a shape which has lens effects. However, in the first embodiment, upper and lower surfaces of the substrate 2 and upper and lower surfaces of the substrate 3 each have a curved surface. The diffractive grating portion 10 has a concentric diffractive grating shape having a center at an optical axis O, and has the lens effects.

In other words, a diffractive grating 11 as a first diffractive grating and a diffractive grating 12 as a second diffractive grating on the output side realize the lens effects (a light converging effect and a light diverging effect) by changing a grating pitch gradually from the optical axis O toward an outer periphery. A first grating surface 11a and a second grating surface 12a, and first grating wall surfaces 11b and second grating wall surfaces 12b are closely contact with each other without forming a gap therebetween, and the diffractive gratings 11 and 12 as a whole work as the single DOE 1.

FIG. 1B is a partial enlarged perspective view of the diffractive grating portion 10. FIG. 1C is an enlarged cross-sectional view of FIG. 2. The gratings are significantly deformed in the depth direction, and the number of gratings is reduced from the actual number in order to make the shapes of gratings easily understood. In FIG. 1B and FIG. 1C, an incident optical flux a is an optical flux incident at an incident angle of 0°, which corresponds to a designed incident angle of the DOE 1. An incident optical flux b is an optical flux incident downward at an inclined incident angle (out-of screen light incident angle). An incident optical flux c is an optical flux incident upward at an inclined incident angle (out-of screen light incident angle).

In FIGS. 1A, 1B, and 1C and FIG. 2, the diffractive grating portion 10 is formed by contacting the diffractive grating (first diffractive grating) 11 and the diffractive grating (second diffractive grating) 12 in a tight manner in the direction of an optical axis, and a transparent thin film 20 having a used wavelength range are provided on the grating wall surfaces of the diffractive grating 11 and the diffractive grating 12. Here, the diffractive grating portion 10 may be formed of only one of the diffractive grating (first diffractive grating) 11 and the diffractive grating (second diffractive grating) 12. The diffractive grating 11 may be integral with the substrate 2 or may be a separate member. In the same manner, the diffractive grating 12 may be integral with the substrate 3 or may be a separate member.

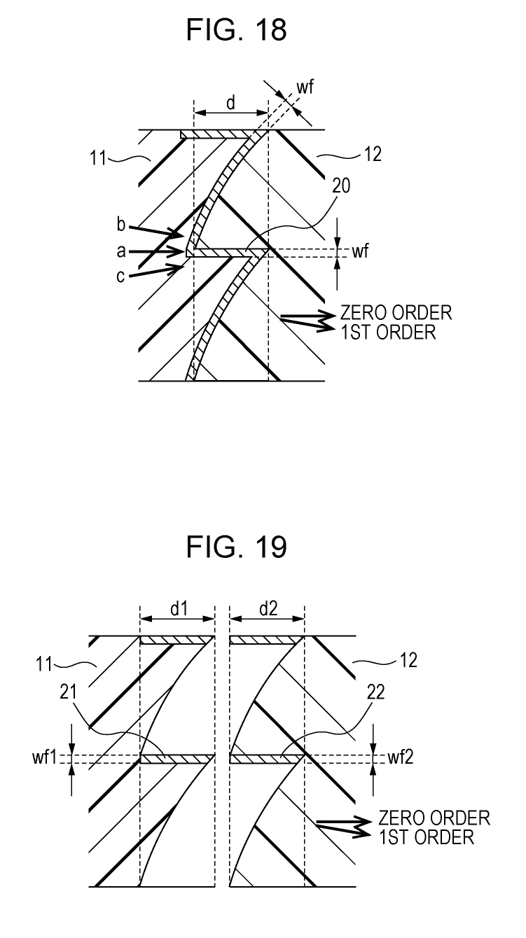

In the first embodiment, the diffractive gratings 11 and 12 are in closely contact with each other in the direction of an optical axis. However, the thin film 20 interposed therebetween may be formed over the entire range of both of the diffractive gratings 11 and 12 as illustrated in FIG. 18 described later, so that what is essential is that the diffractive gratings 11 and 12 are laminated in the direction of the optical axis.

### Blazed Structure

The diffractive grating 11 has a concentric blazed structure including the first grating surfaces 11a and the first grating wall surfaces 11b, and the diffractive grating 12 includes a concentric blazed structure including the second grating surfaces 12a and the second grating wall surfaces 12b. With the blazed structure, the incident light incident on the DOE 1 is diffracted intensively in a direction of diffraction of a designed order (+1st in the drawing) in contrast to a direction of the zero-order in which the light is transmitted without being diffracted by the diffractive grating portion 10.

### High Diffraction Efficiency in Entire Visible Range

Since the used wavelength range of the DOE 1 of the first embodiment is a visible range, the materials of the diffractive gratings 11 and 12 and the heights of the gratings are selected on the basis of the scalar diffraction theory, so that the diffraction efficiency of the diffracted light beam of the designed order is improved over the entire visible range. In other words, the materials of the respective diffractive gratings and the heights of the gratings are determined so that the maximum optical path length difference (the maximum value of the optical path length between peaks and troughs of the diffractive portion) of light passing through a plurality of the diffractive gratings (diffractive gratings 11 and 12) becomes a value near integral multiple of the wavelength thereof within the used wavelength range. The materials and the shapes of the diffractive gratins are set adequately in this manner, so that a high diffraction efficiency is obtained in the entire used wavelength range.

In general, the height of the diffractive grating is defined by the height between distal ends of the grating and the grooves of the grating in the direction perpendicular to the direction of cycle of the grating (the surface-normal direction). In a case where the grating wall surfaces are shifted from the surface-normal direction or when the distal ends of the grating are deformed, the height of the diffractive grating is defined by a distance to an intersection point between an extension of the grating surface and the surface normal. The materials of the diffractive gratings and the height of the gratings are not limited.

In the first embodiment, the diffractive gratings 11 and 12 are formed of materials different from each other. The diffractive grating 11 is formed of a low refractive index dispersed material, and the diffractive grating 12 is formed of a high refractive index dispersed material having a higher refractive index than the diffractive grating 11. By satisfying the expression given below, a high, 99% or more diffraction efficiency may be obtained.

νd1<25

νd2>35

0.940≦(n12×d1−n11×d2)/(m×λ)<1.060

where n11 and n12 are refractive indexes of materials which constitute the diffractive grating 11 and the diffractive grating 12, and νd1 and μd2 are Abbe numbers of the same, and d1 and d2 are the heights of grating at a wavelength of λ, and m is the designed order.

In order to obtain a diffraction efficiency as high as 99% or higher in the entire range of the visible wavelength band, it is preferable to set the Abbe number of the high refractive index dispersed material to be larger than 35 and the Abbe number of the low refractive index dispersed material to be smaller than 25. Furthermore, it is preferable to use a material having a value of partial dispersion ratio θgF smaller than that of the normal materials (linear anomalous dispersion). In order to obtain the liner dispersion characteristic, a method of dispersing the ITO fine particles and mixing with a base resin material may be employed. Unlike other organic oxides, ITO has a characteristic that the refractive index, in addition to a change of the refractive index due to electron transfer, a free carrier is generated due to doping by tin or cavity of oxygen, so that the refractive index changes.

Due to influences of the electron transfer and the free carrier, a very strong linear dispersion characteristic is provided. Therefore, in the same manner as ITO, SnO2 and ATO (SnO2 doped with antimony) that is subject to the free carrier may also be used.

The resin material in which the fine particles are dispersed is a UV cured rein, and includes any one of acrylic, fluorinated, vinyl, and epoxy-based organic resins, but is not limited thereto. An average particle diameter of the fine particle material is preferably ¼ or smaller of the wavelength of the incident light (used wavelength or designed wavelength) on the diffraction optical element. If the particle diameter is larger, Rayleigh scattering may become severe when the fine particle material is mixed with the resin material.

### Thin Film

The thin film 20 is provided at least part of a boundary plane between the diffractive gratings 11 and 12 at a substantially uniform thickness. In the first embodiment, the thin film 20 is provided between the grating wall surfaces of the first diffractive grating and the grating wall surfaces of the second diffractive grating along the grating wall surfaces. In the first embodiment in which the diffractive grating portion of a laminated type is provided, the thin film is provided along the grating wall surfaces of the first diffractive grating or the second diffractive grating. However, in the case in which the diffractive grating portion is composed only of the second diffractive grating, the thin film is provided along the grating wall surfaces of the second diffractive grating.

With the provision of the high-reflective index thin film on the grating wall surfaces, this disclosure utilizes a property that part of an optical flux is trapped in the interior of the high-refractive index thin film, the trapped light flux is propagated like an optical waveguide via a multiple reflection caused by total reflection and goes out from the thin film, and then the optical flux interfere with an optical flux which does not pass through the thin film. It was found that when the conditions of the optical waveguide are optimized, light going out from the diffractive grating is combined with the diffracted light beam of the designed diffraction order and, consequently, the diffraction efficiency of the designed order is improved, and the diffraction efficiencies of one order higher and lower the designed order is reduced. As a result of earnest study, Expressions (1) and (2) are obtained as preferable conditions.

0.05<nfd−ngd<0.5, (1)

0.01<(nfd−ngd)*wf/λd<0.05 (2)

where nfd is a refractive index of the thin film with respect to a d line, ngd is a refractive index of a material of the diffractive grating with respect to the d line (when the diffractive grating portion is composed only of the second diffractive grating without the first diffractive grating), wf is a film thickness of a thin film, and λd is a wavelength of the d line.

When the diffractive grating portion is composed of the first diffractive grating and the second diffractive grating here, the following conditions are to be satisfied. In other words, in the diffraction optical element of the laminated type illustrated in FIG. 1 to FIG. 3, where nd1 and nd2 are the refractive indexes of the materials of the first and second diffractive gratings with the d line, nfd is a refractive index with the d line of the thin film, wf is a thickness of the thin film, and λd is a wavelength of the d line, the following expressions are to be satisfied,

nd1<nd2 (3)

0.05<nfd−nd2<0.5 (4)

0.01<(nfd−nd2)*wf/λd<0.05 (5)

Here, an example in which nd2 is larger than the refractive index nd1 of the material which constitutes the diffractive grating 11 with respect to the d line will be described. In contrast when a relation of nd2<nd1 is satisfied, the direction of the grating shape of the diffractive grating is inverted, and the influence of the unnecessary light due to the grating wall surfaces becomes the same.

It is also preferable that the following expression is satisfied, where kgd is an extinction coefficient of the material of the diffractive grating with the d line, and kfd is an extinction coefficient of the thin film with the d line. If the following expression is not satisfied, reflection occurs on the thin film and hence the advantages described above can hardly be achieved.

0≦kfd−kgd<0.5 (6)

The method of manufacturing the thin film 20 is not specifically limited. For example, the diffractive grating 12 is manufactured, and then the thin film 20 is selectively formed. Specifically, a method of forming a thin film with the material of the thin film by using a physical deposition method such as vacuum deposition or a spin coat method, patterning by using lithography method or nanoimprint method or the like, and selectively performing etching method or the like may be employed. A method of forming the thin film or the like by selectively using a deposition method or the like with a mask pattern may be used.

There is a case where the thin film 20 is formed over the entire range of the boundary plane between the both diffractive gratings as described later. In such a case, it is not necessary to form the thin film selectively on the grating wall surface portions only. Subsequently, the diffractive grating 11 is formed to manufacture the diffraction optical element. Alternatively, the thin film may be formed on every circle zones under control by changing the width or the shape of the thin film from one circle zone to another of the diffraction optical element.

Referring now to the attached drawings, detailed examples will be described.

### Example 1

In Example 1, the diffractive grating 11 is formed of an acrylic UV cured resin mixed with ITO fine particles (nd=1.5631, νd=18.4, θgF=0.422, n550=1.5698). The diffractive grating 12 is formed of an acrylic UV cured resin mixed with ZrO₂ fine particles (nd=1.6196, νd=43.6, θgF=0.569, n550=1.6277) mixed with ZrO₂ fine particles.

The value nd of each of the diffractive grating 11 and the diffractive grating 12 is a refractive index with respect to the d line, νd is Abbe number with respect to the d line, θgF is partial dispersion ratios with respect to a g line and an F line, and n550 is a refractive index with respect to a wavelength of 550 nm.

The height of grating of the grating wall surfaces illustrated in FIG. 1B is 10.40 μm, the designed order is +1st order. The thin film 20 has a refractive index with respect to the d line, nd=1.80, and an extinction coefficient, kd=0.0, and has the film thickness wf in the direction perpendicular to the grating wall surfaces, which correspond to a plane to be laminated, is 80 nm.

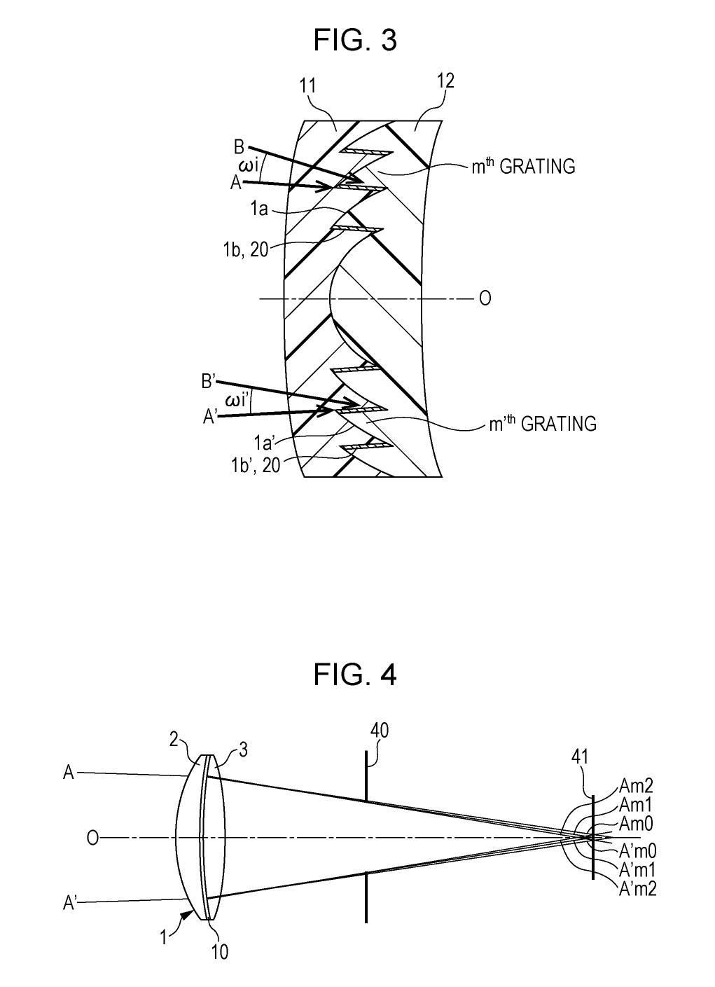

FIG. 3 is a partially enlarged cross-sectional view of FIG. 1B, and FIG. 4 is a schematic drawing for explaining an influence of unnecessary light at a designed incident angle (incident angle of image taking light). In FIG. 3 and FIG. 4, image-taking optical fluxes A and A′ incident on the optical axis O pass through the substrate 2, and then enter mth grating and m′^{th} grating, which correspond to the m^{th} diffractive grating counted upward from the optical axis O and m^{th} diffractive grating counted downward from the optical axis O, respectively. In FIG. 4, incident angles of the image-taking optical fluxes A and A′ onto the m^{th} grating and the m′^{th} grating are directions of the center of gravity light beam. The direction of the grating wall surfaces is equal to the direction of the center of gravity light beam.

In FIG. 4, a +1st order diffracted light beam going out from the m^{th} grating of the image-taking optical flux A is indicated by Am1, 0th diffracted light beam is indicated by Am2, +2nd order diffracted light beam is indicated by Am2, +1st order diffracted light beam going out from the m′^{th} grating of the image-taking optical flux A′ is indicated by A′m1, zero-order diffraction light is indicated by A′m0, and +2nd order diffracted light beam is indicated by A′m2. The +1st order diffracted light beams Am1 and A′m1, which are the designed order, are imaged on the imaging surface 41. In contrast, the zero-order diffraction lights Am0 and A′m0 which corresponds to the order which is one order below the designed order are imaged on an image side of the imaging surface 41, and +2nd order diffracted light beams Am2 and A′m2, which correspond to the order which is one order higher than the designed order, are imaged on the object side of the imaging surface 41. The more the spot size on the imaging surface comes away from the designed order, the more the image appear blurred, and hence the unnecessary light becomes indistinctive.

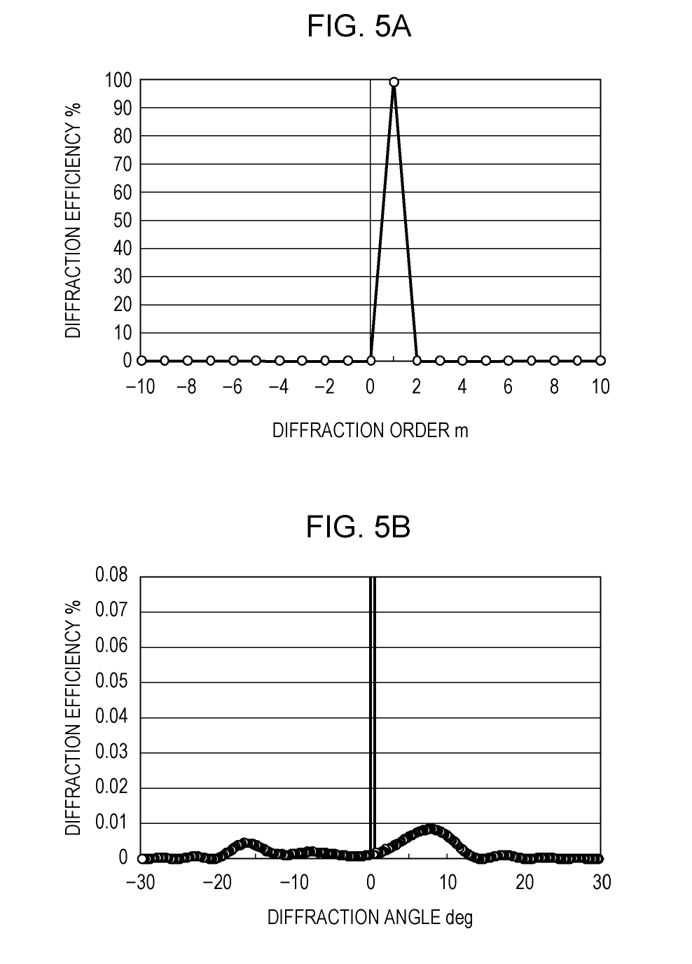

In other words, the unnecessary light at the designed incident angle (incident angle of image taking light) have a largest influence on the diffraction efficiency of the diffracted light beam of one order higher and lower the designed orders. FIG. 5 is a graph showing a result of RCWA calculation at an incident angle of 0°, a grating pitch of 100 μm, and a wavelength of 550 nm assuming the incident optical flux a, which is a designed incident angle (incident angle of image taking light) illustrated in FIG. 1C and the incident optical flux A illustrated in FIG. 3 and FIG. 4.

FIG. 5A illustrates the diffraction efficiency near the +1st order diffracted light beam, which is the designed order. The lateral axis represents the diffraction order, and the vertical axis represents the diffraction efficiency. FIG. 5B shows a result of enlarging a portion of the vertical axis in FIG. 5A where the diffraction efficiency is low and changing the lateral axis from the diffraction order to diffraction angle to illustrate a high-diffraction angular range. The positive direction of the diffraction angle corresponds to a downward direction in FIG. 1C.

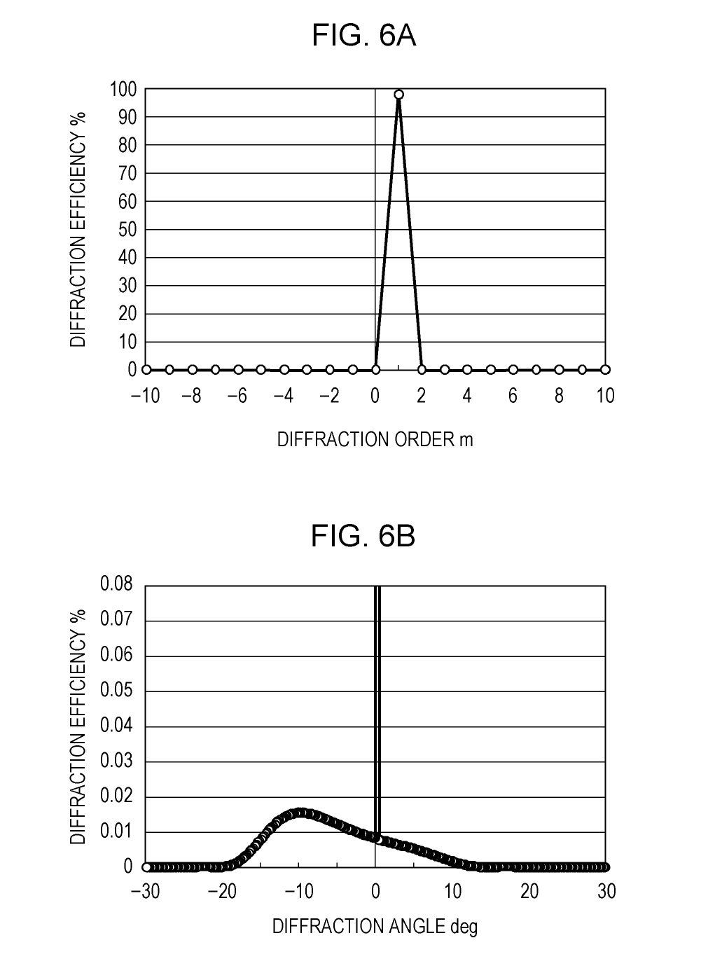

FIG. 6 is a graph as a comparative example corresponding to FIG. 5 and illustrates a case where a DOE having the same configuration as in FIG. 1 except that the thin film 20 is not provided is used. As is understood from FIG. 5A, the diffraction efficiency of the +1st order diffracted light beam, which is the designed order, is 99.43% (diffraction angle, +0.19°), which is significantly improved from the diffraction efficiency of 98.71% (diffraction angle, +0.19°) of the +1st order diffracted light beam in a case where the thin film is not provided as in FIG. 6A.

As is understood from FIG. 5B, the diffraction efficiencies of the zero-order diffraction light and +2nd order diffracted light beam are 0.00126% and 0.00120%, respectively, which is significantly reduced from the diffraction efficiencies of the zero-order diffraction light and the +2nd order diffracted light beam in the case where the thin film is not provided as in FIG. 6B. The values indicated in FIG. 6B are 0.00841% and 0.00774%, respectively. Although the numerical values of the diffraction efficiencies of the zero-order diffraction light and the +2nd order diffracted light beam themselves are low, since these values have an influence as unnecessary light when image is taking with a high-luminance light source, low apertures, and a long-time exposure or the like, the large advantages are achieved in the first embodiment.

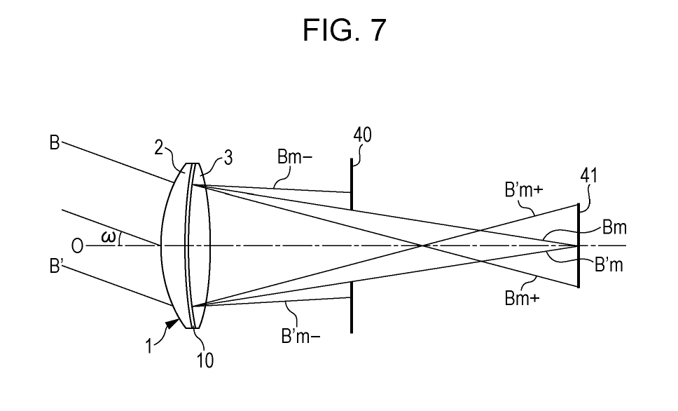

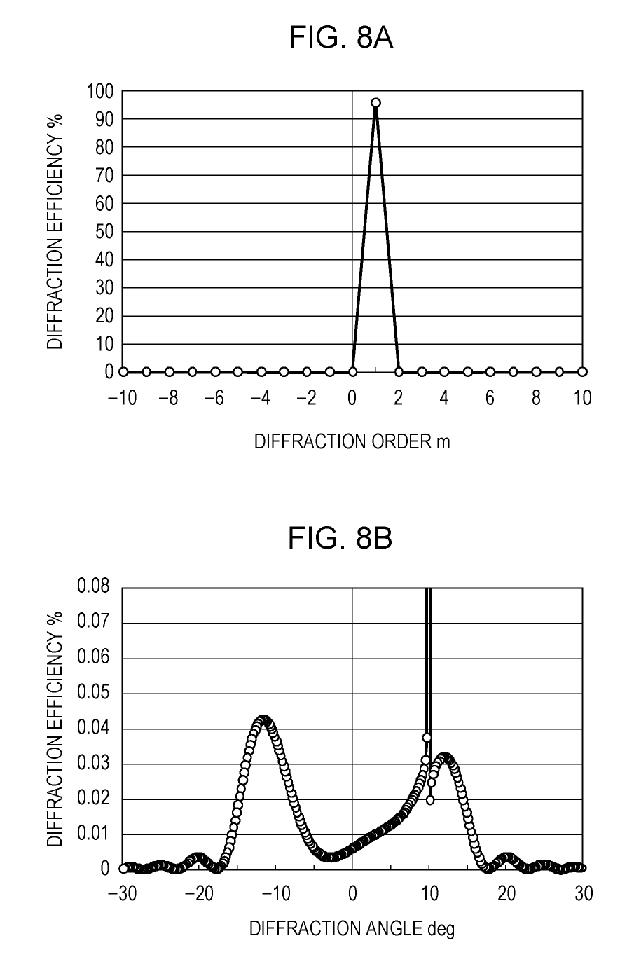

FIG. 7 is a schematic drawing for explaining an influence of the unnecessary light at the inclined incident angle (out-of screen light incident angle). In FIG. 3, the incident angles of out-of-screen optical fluxes B and B′ with respect to the m^{th} grating and the m′^{th} grating are ωi and ω′ with respect to the direction of the center of gravity light beam. FIG. 8 is a graph showing the out-of-screen incident optical flux b illustrated in FIG. 1C and a result of RCWA calculation at an incident angle of +10°, a grating pitch of 100 μm, and a wavelength of 550 nm assuming the incident optical flux B illustrated in FIG. 3 and FIG. 7. The positive direction of the incident angle corresponds to a downward direction in FIG. 1C.

FIG. 8A illustrates the diffraction efficiency near the +1st order diffracted light beam, which is the designed order. The lateral axis represents the diffraction order, and the vertical axis represents the diffraction efficiency. FIG. 8B shows a result of enlarging a portion of the vertical axis in FIG. 8A where the diffraction efficiency is low and changing the lateral axis from the diffraction order to diffraction angle to illustrate a high-diffraction angular range. The positive direction of the diffraction angle corresponds to a downward direction in FIG. 1C. As illustrated in FIG. 8A, although the diffraction efficiency of the +1st order diffracted light beam, which is the designed order, is intensively high, the +1st order diffracted light beam does not reach the imaging surface, and hence no significant influence results.

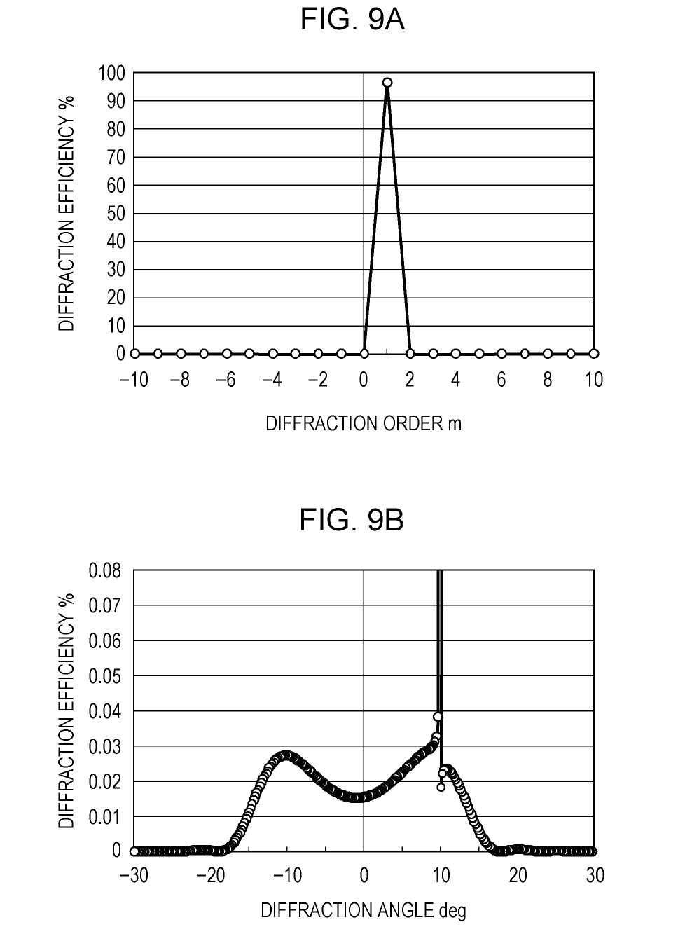

The remaining unnecessary light is propagated as unnecessary light having peaks at a specific angular direction as illustrated in FIG. 8B. The unnecessary light has a peak in the substantially −10° direction, and the direction of propagation thereof is substantially the same as the outgoing direction of −10°, which is a direction of propagation of the component of an optical flux at an out-of-screen incident angle of +10°, which enters the grating wall surfaces after the total reflection. FIG. 9 is a graph as a comparative example corresponding to FIG. 8 and illustrates a case where a DOE having the same configuration as in FIG. 1C except that the thin film 20 is not provided is used.

Part of the unnecessary light incident at an out-of-screen angle of +10°, which goes out near a diffraction angle of the +1st order diffracted light beam, which is the designed incident angle, plus 0.19° reaches the imaging surface (Bm in FIG. 7). The diffraction order and the diffraction angle at which the undesirable part of the out-of-screen incident light reaches the imaging surface varies depending on the optical system on the downstream side of the diffraction optical element (Bm to Bm+ in FIG. 7). However, with any optical system, the diffracted light beam from the undesirable part of the out-of-screen light, which substantially matches the diffraction angle at which light having the designed diffraction order light beam at least at the designed angle is propagated, reaches the imaging surface, so that lowering of the image performance may result.

The peak angle of the unnecessary light at −10° direction illustrated in FIG. 8B is substantially the same as FIG. 9B. However, the spread of the unnecessary light is different between FIG. 8B and FIG. 9B. The diffraction efficiency near a diffraction angle of +0.19° is 0.00661% for the −48^{th} order diffracted light beam (a diffraction angle of +0.30°) and 0.00633% for the −49^{th} order diffracted light beam (a diffraction angle of +0.11°) from the result of RCWA calculation. In contrast, in the comparative example in which the thin film is not provided, the diffraction efficiency is 0.0156% for the −48^{th} order diffracted light beam (a diffraction angle of +0.30°) and 0.0155% for the −49^{th} order diffracted light beam (a diffraction angle of +0.11°), and hence the influence of the unnecessary light is significantly reduced in Example 1.

In Example 1, it is considered that the amount of the optical flux that reaches the imaging surface is smaller than that in the comparative example because the part of the optical flux b incident on a portion near the grating wall surfaces is trapped in the interior of the thin film 20, is propagated like the optical waveguide, and interferes with the unnecessary light after having gone out.

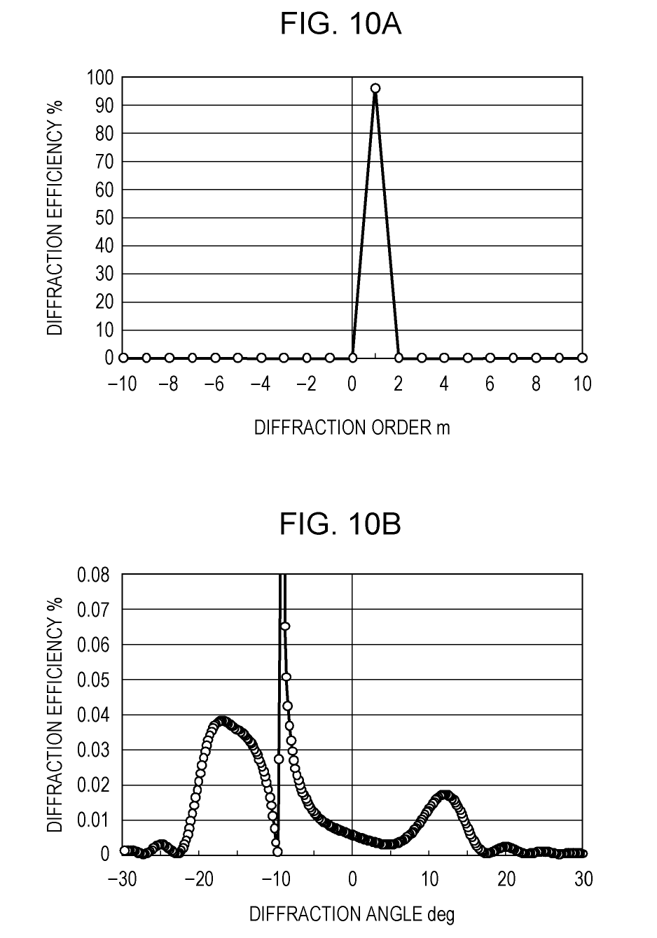

Subsequently, FIG. 10 is a graph illustrating a result of RCWA calculation at an incident angle of −10°, a grating pitch of 100 μm, and a wavelength of 550 nm assuming the incident optical flux c illustrated in FIG. 1C. The positive direction of the incident angle corresponds to a downward direction in FIG. 1C (at the m′^{th} grating in FIG. 3, the upward direction corresponds to the positive direction). FIG. 10A illustrates the diffraction efficiency near the +1st order diffracted light beam, which is the designed order. The lateral axis represents the diffraction order, and the vertical axis represents the diffraction efficiency. FIG. 10B shows a result of enlarging a portion of the vertical axis in FIG. 10A where the diffraction efficiency is low and changing the lateral axis from the diffraction order to diffraction angle to illustrate a high-diffraction angular range.

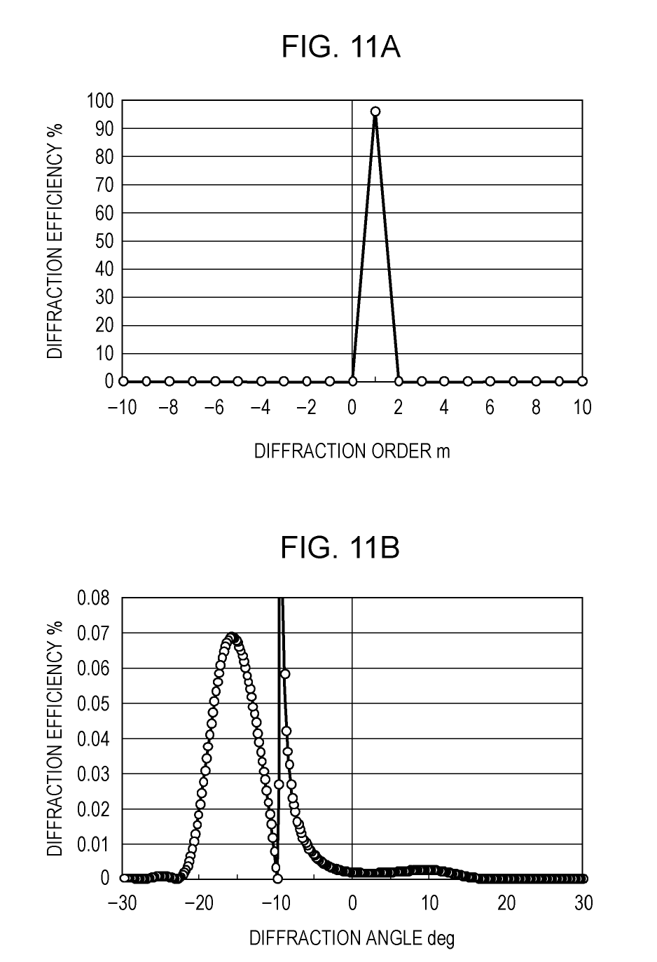

FIG. 11 is a graph as a comparative example corresponding to FIG. 10 and illustrates a case where a DOE having the same configuration as in FIG. 1C except that the thin film 20 is not provided is used. As illustrated in FIG. 10A, although the diffraction efficiency of the +1st order diffracted light beam, which is the designed order, is intensively high, the +1st order diffracted light beam does not reach the imaging surface, and hence no significant influence results. It is understood that the remaining unnecessary light is propagated as unnecessary light having a peak at a specific angular direction as illustrated in FIG. 10B. When comparing with FIG. 11B, the peak of the unnecessary light in the positive direction is increased and the unnecessary light in the negative direction is reduced.

It means that part of the optical flux incident on the grating wall surfaces from the low refractive index medium side reflects by the high refractive index thin film provided on the grating wall surfaces, so that the unnecessary light in the positive direction is increased, and the unnecessary light caused by passage in the negative direction is reduced.

In the optical system illustrated in FIG. 2 and FIG. 7, the diffracted light beam from the undesirable part of the out-of-screen light, which substantially matches a diffraction angle of +0.19° at which light having the designed diffraction order light beam incident at least at the designed angle is propagated, reaches at least the imaging surface (B′m in FIG. 7). The diffraction efficiency near a diffraction angle of +0.19 is 0.00526% for the +51th order diffracted light beam (a diffraction angle of +0.28°) and 0.00541% for the +5zero-order diffraction light (a diffraction angle of +0.065°) from the result of RCWA calculation. In contrast, in the case of the comparative example (FIG. 11), the diffraction efficiency is 0.00174% for the +51th order diffracted light beam (a diffraction angle of +0.28°) and 0.00177% for the +5zero-order diffraction light (a diffraction angle of +0.065°).

Accordingly, in Example 1, the numerical value of the diffraction efficiency is extremely small even though it is increased in comparison with the comparative example, and an influence of the m grating is dominant. Therefore, an influence on the lowering of the image performance is not significant. In this manner, in the optical system on which the diffraction optical element of Example 1 is applied, the increase in the unnecessary light at the m′ grating which is less affected by the unnecessary light is controlled to be a level having little influence, so that the unnecessary light at the m grating having a large influence may be significantly reduced. Consequently, the unnecessary light that reaches the imaging surface is reduced, so that lowering of the image performance is suppressed.

The grating pitch here is 100 μm. In the circle band having a wider grating pitch, contribution of the wall surfaces is reduced, so that the diffraction efficiency of the designed order is relatively high, and the diffraction efficiency of the unnecessary light is relatively low. Although not illustrated, the direction of propagation of the unnecessary light does not depend on the grating pitch, and the direction of propagation is the same. Therefore, the diffraction efficiency of the grating pitch of 100 μm is shown as a reference.

Here, the incident angles of the out-of-screen optical fluxes B and B′ are assumed to be +10° out of screen (incident angle ω with respect to the direction of the optical axis is +13.16°) At angles smaller than the incident angle, ghost caused by reflection from the lens surface or the imaging surface and scattering in the interior of the lens or minute depressions and projections on the surface occur much, the unnecessary light of the diffraction optical element is relatively indistinctive. At angles larger than the incident angle, the degree of influence of the unnecessary light of the diffraction optical element is relatively small owing to the reflection from the front lens surface or light-blocking by a lens barrel. Therefore, the out-of-screen incident optical flux has the largest influence on the unnecessary light of the diffraction optical element at a position near the +10°, where the incident angle of out-of-screen light flux is assumed to be substantially +10°.

### Example 2

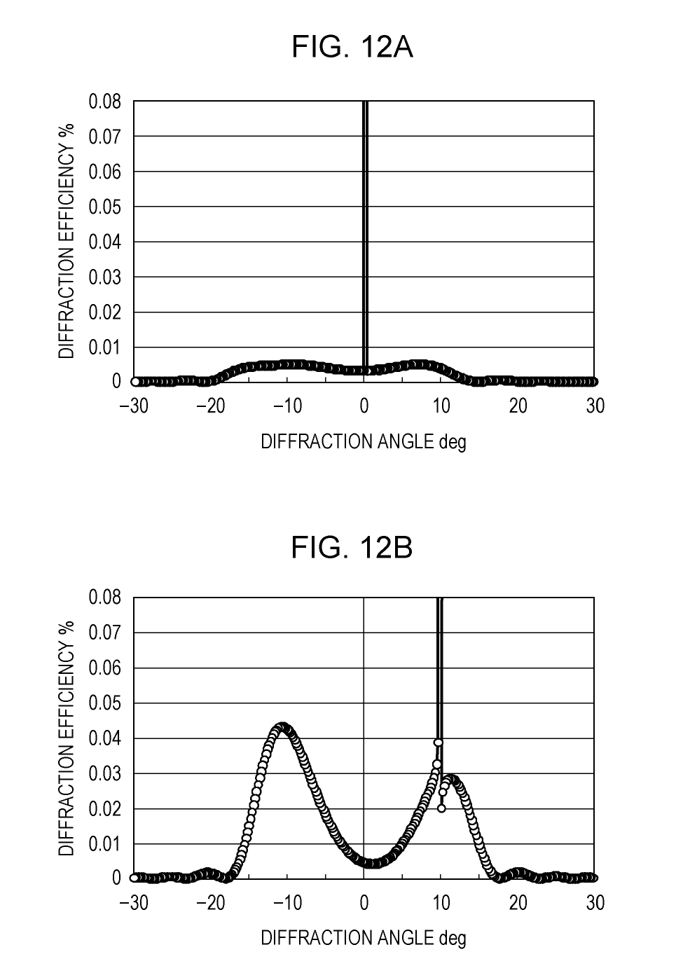

In contrast to Example 1, the film thickness wf of the thin film in Example 2 is 60 nm. FIG. 12A is a graph illustrating a result of RCWA calculation at an incident angle of 0°, a grating pitch of 100 μm, and a wavelength of 550 nm. The diffraction efficiency of the +1st order diffracted light beam, which is the designed order, is 99.36%, which is significantly improved from the diffraction efficiency of 98.71% of the +1st order diffracted light beam in a case where the thin film is not provided.

The diffraction efficiencies of zero-order refracted light beam and +2nd order diffracted light beam in FIG. 12A are 0.00305% and 0.00321%, respectively. In contrast, in the case of the diffractive grating which is not provided with the thin film illustrated in FIG. 6B, the diffraction efficiencies of zero-order refracted light beam and +2nd order diffracted light beam are 0.00841% and 0.00774%, respectively, and are significantly reduced in Example 2.

FIG. 12B is a graph illustrating a result of RCWA calculation at +10°, a grating pitch of 100 μm, and a wavelength of 550 nm. The diffraction efficiency is 0.00431% for the −48th order diffracted light beam and 0.00443% for the −49th order diffracted light beam. In contrast, in the comparative example in which the thin film is not provided, the diffraction efficiency is 0.0156% for the −48^{th} order diffracted light beam and 0.0155% for the −49^{th} order diffracted light beam, and hence the influence of the unnecessary light is significantly reduced in Example 2.

### Example 3

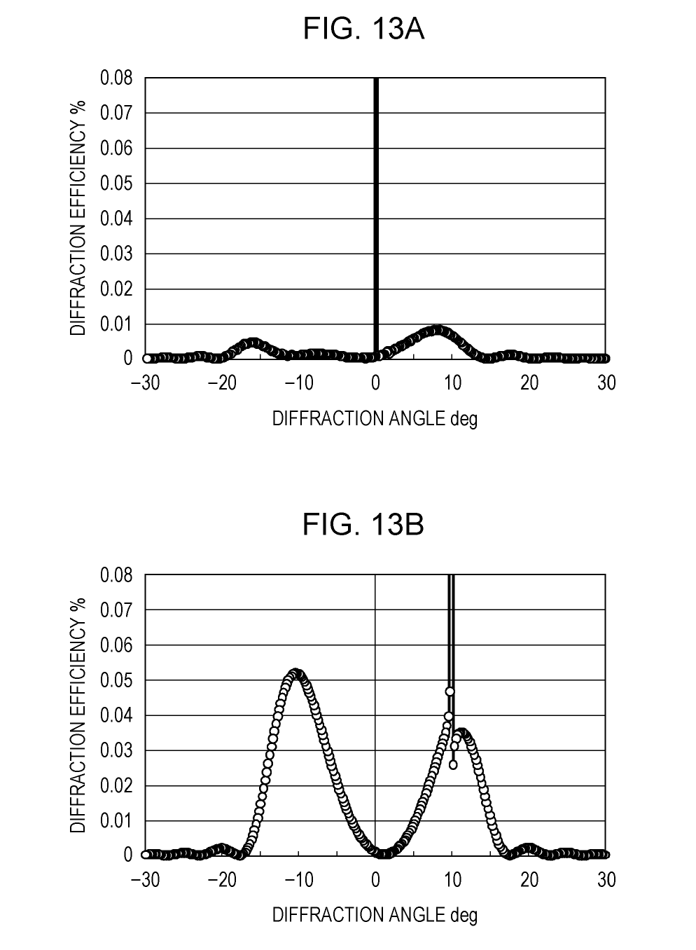

In contrast to Example 1, the refractive index of the thin film is 1.7 and the film thickness wf is 160 nm in Example 3. FIG. 13A is a graph illustrating a result of RCWA calculation at an incident angle of 0°, a grating pitch of 100 μm, and a wavelength of 550 nm. The diffraction efficiency of the +1st order diffracted light beam, which is the designed order, is 99.49%, which is significantly improved from the diffraction efficiency of 98.71% of the +1st order diffracted light beam in a case where the thin film is not provided.

The diffraction efficiency of zero-order refracted light beam and +2nd order diffracted light beam in FIG. 13A are 0.000759% and 0.000613%, respectively. In contrast, in the case of the diffractive grating which is not provided with the thin film illustrated in FIG. 6B, the diffraction efficiencies of zero-order refracted light beam and +2nd order diffracted light beam are 0.00841% and 0.00774%, respectively, and are significantly reduced.

FIG. 13B is a graph illustrating a result of RCWA calculation at +10°, a grating pitch of 100 μm, and a wavelength of 550 nm. The diffraction efficiency is 0.00577% for the −48th order diffracted light beam and 0.00768% for the −49th order diffracted light beam. In contrast, in the comparative example in which the thin film is not provided, the diffraction efficiency is 0.0156% for the −48^{th} order diffracted light beam and 0.0155% for the −49^{th} order diffracted light beam, and hence the influence of the unnecessary light is significantly reduced in Example 3.

### Example 4

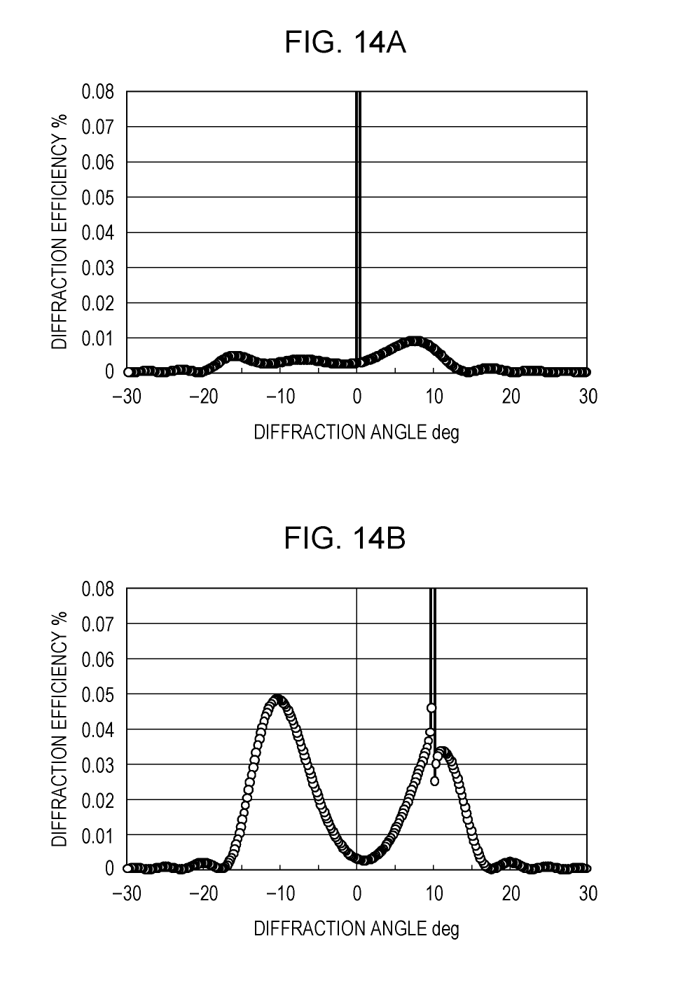

In contrast to Example 1, the refractive index of the thin film is 2.0 and the film thickness wf is 40 nm in Example 4. FIG. 14A is a graph illustrating a result of RCWA calculation at an incident angle of 0°, a grating pitch of 100 μm, and a wavelength of 550 nm. The diffraction efficiency of the +1st order diffracted light beam, which is the designed order, is 99.28%, which is significantly improved from the diffraction efficiency of 98.71% of the +1st order diffracted light beam in a case where the thin film is not provided.

The diffraction efficiency of zero-order refracted light beam and +2nd order diffracted light beam in FIG. 14A are 0.00269% and 0.00262%, respectively. In contrast, in the case of the diffractive grating which is not provided with the thin film illustrated in FIG. 6B, the diffraction efficiencies of zero-order refracted light beam and +2nd order diffracted light beam are 0.00841% and 0.00774%, respectively, and are significantly reduced.

FIG. 14B is a graph illustrating a result of RCWA calculation at +10°, a grating pitch of 100 μm, and a wavelength of 550 nm. The diffraction efficiency is 0.00268% for the −48th order diffracted light beam and 0.00280% for the −49th order diffracted light beam. In contrast, in the comparative example in which the thin film is not provided, the diffraction efficiency is 0.0156% for the −48^{th} order diffracted light beam and 0.0155% for the −49^{th} order diffracted light beam, and hence the influence of the unnecessary light is significantly reduced in Example 4.

### Example 5

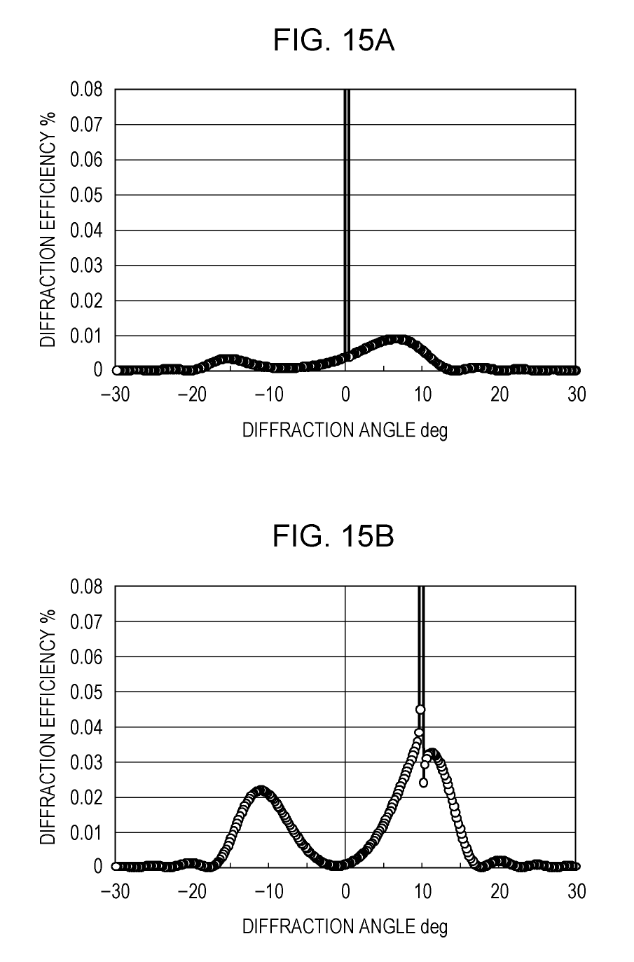

In contrast to Example 1, the refractive index of the thin film is 1.8, the extinction coefficient kf is 0.05, and the film thickness wf is 80 nm in Example 5. FIG. 15A is a graph illustrating a result of RCWA calculation at an incident angle of 0°, a grating pitch of 100 μm, and a wavelength of 550 nm. The diffraction efficiency of the +1st order diffracted light beam, which is the designed order, is 99.39%, which is significantly improved from the diffraction efficiency of 98.71% of the +1st order diffracted light beam in a case where the thin film is not provided.

The diffraction efficiency of zero-order refracted light beam and +2nd order diffracted light beam in FIG. 15A are 0.00400% and 0.00394%, respectively. In contrast, in the case of the diffractive grating which is not provided with the thin film illustrated in FIG. 6B, the diffraction efficiencies of zero-order refracted light beam and +2nd order diffracted light beam are 0.00841% and 0.00774%, respectively, and are significantly reduced.

FIG. 15B is a graph illustrating a result of RCWA calculation at +10°, a grating pitch of 100 μm, and a wavelength of 550 nm. The diffraction efficiency is 0.00104% for the −48th order diffracted light beam and 0.000877% for the −49th order diffracted light beam. In contrast, in the comparative example in which the thin film is not provided, the diffraction efficiency is 0.0156% for the −48^{th} order diffracted light beam and 0.0155% for the −49^{th} order diffracted light beam, and hence the influence of the unnecessary light is significantly reduced in Example 5.

### Example 6

Example 6 shows a case where the materials which constitute the diffractive gratings are different from Example 1 to Example 5. The diffractive grating 11 is formed of a thio acrylic UV cured resin (nd=1.6925, νd=12.9, θgF=0.395, n550=1.7042) mixed with ITO particle. The diffractive grating 12 is formed of K-VC89 (K-VC89 is a name of product from Sumita Optical Glass Inc. nd=1.8100, νd=41.0, θgF=0.567). The refractive index of the thin film is 2.2 and the thickness wf is 60 nm.

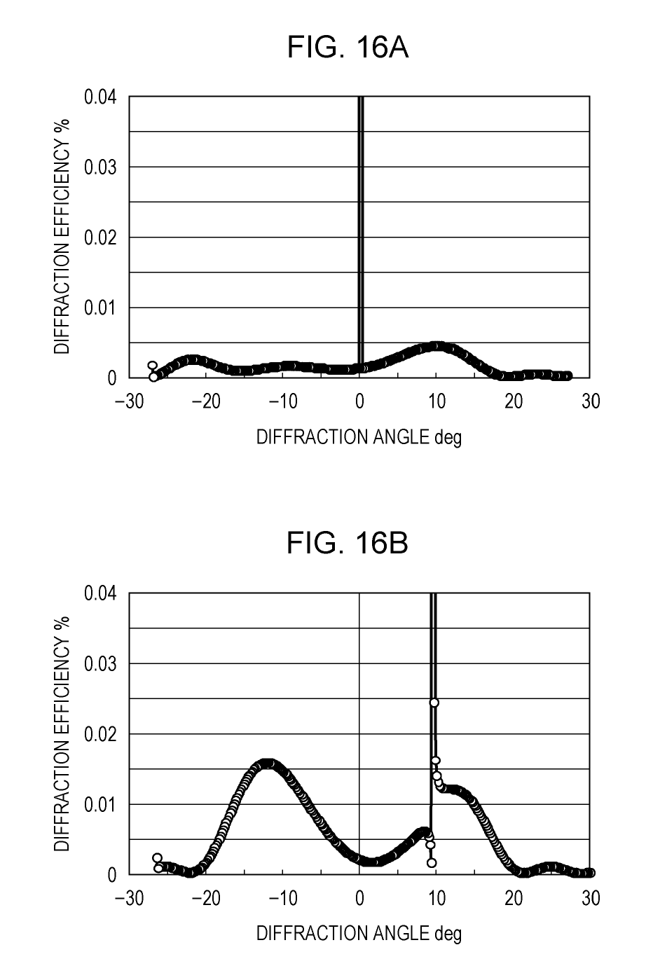

FIG. 16A is a graph illustrating a result of RCWA calculation at an incident angle of 0°, a grating pitch of 100 μm, and a wavelength of 550 nm. The diffraction efficiency of the +1st order diffracted light beam, which is the designed order, is 99.50%, which is significantly improved from the diffraction efficiency of 99.14% of the +1st order diffracted light beam in a case where the thin film is not provided.

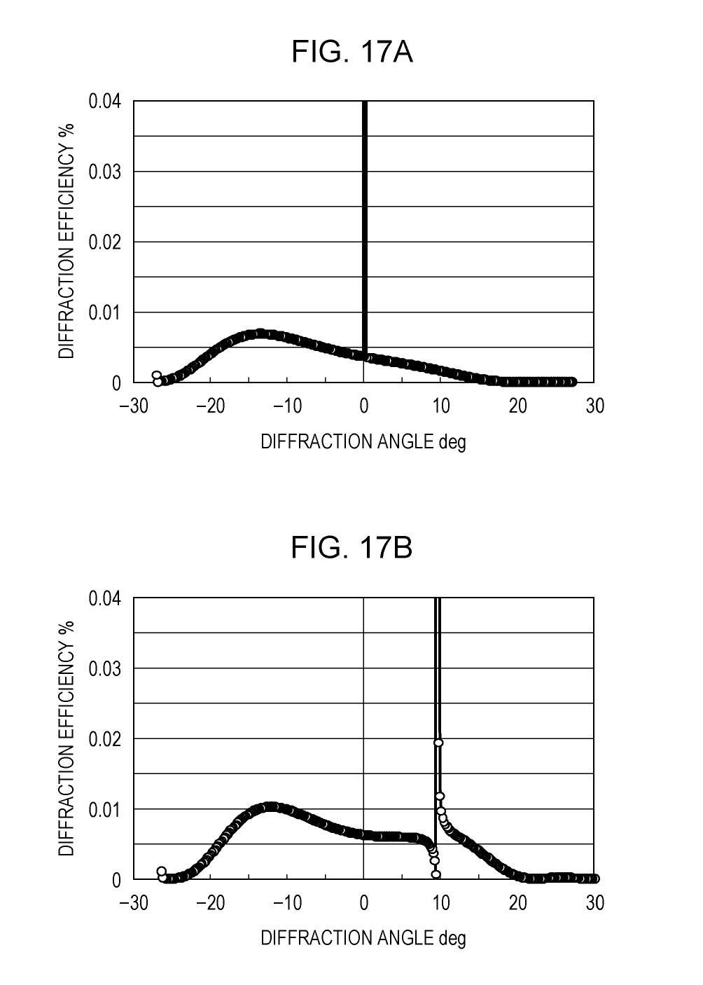

The diffraction efficiency of zero-order refracted light beam and +2nd order diffracted light beam in FIG. 16A are 0.00126% and 0.00127%, respectively. In contrast, in the case of the diffractive grating which is not provided with the thin film illustrated in FIG. 17A, the diffraction efficiencies of zero-order refracted light beam and +2nd order diffracted light beam are 0.00364% and 0.00344%, respectively, and are significantly reduced.

FIG. 16B is a graph illustrating a result of RCWA calculation at +10°, a grating pitch of 100 μm, and a wavelength of 550 nm. The diffraction efficiency is 0.00171% for the −48th order diffracted light beam and 0.00174% for the −49th order diffracted light beam. In contrast, in the comparative example which is not provided with the thin film illustrated in FIG. 17B, the diffraction efficiency is 0.00612% for the −48th order diffracted light beam and 0.0614% for the −49th order diffracted light beam. Therefore, the influence of the unnecessary light in Example 6 is significantly reduced.

Table 1 is a table in which the results of Examples 1 to 6 are summarized. The sign nd1 denotes the refractive index of the diffractive grating 11 with the d line, the sign nd2 denotes the refractive index of the diffractive grating 12 with the d line. The sign of denotes the refractive index of the thin film, and the sign wf denotes a film width of the thin film.

TABLE 1

| | | | | | | | COMPARATIVE | COMPARATIVE |
|---|---|---|---|---|---|---|---|---|
| | Example 1 | Example 2 | Example 3 | Example 4 | Example 5 | Example 6 | Example | Example |
| nd1 | 1.5631 | 1.5631 | 1.5631 | 1.5631 | 1.5631 | 1.6925 | 1.5631 | 1.6925 |
| nd2 | 1.6196 | 1.6196 | 1.6196 | 1.6196 | 1.6196 | 1.8100 | 1.6196 | 1.8100 |
| nfd | 1.8 | 1.8 | 1.7 | 2.0 | 1.8 | 2.2 | — | — |
| kfd | 0.0 | 0.0 | 0.0 | 0.0 | 0.05 | 0.0 | — | — |
| Wf(nm) | 80 | 60 | 160 | 40 | 80 | 60 | — | — |
| Nfd − nd2 | 0.18 | 0.18 | 0.08 | 0.38 | 0.18 | 0.39 | — | — |
| (nfd − nd2) * wf/λd | 0.0246 | 0.0184 | 0.0219 | 0.0259 | 0.0246 | 0.0398 | — | — |
| 0° incident diffraction | | | | | | | | |
| efficiency (%) | | | | | | | | |
| +1st order | 99.43 | 99.36 | 99.49 | 99.28 | 99.39 | 99.50 | 98.71 | 99.14 |
| zero-order | 0.00126 | 0.00305 | 0.000759 | 0.00269 | 0.00400 | 0.00126 | 0.00841 | 0.00364 |
| +2nd order | 0.00120 | 0.00321 | 0.000613 | 0.00262 | 0.00394 | 0.00127 | 0.00774 | 0.00344 |
| +10° incident diffraction | | | | | | | | |
| efficiency (%) | | | | | | | | |
| -48th order | 0.00661 | 0.00428 | 0.000577 | 0.00268 | 0.00104 | 0.00171 | 0.0156 | 0.00612 |
| -49th order | 0.00633 | 0.00458 | 0.000768 | 0.00280 | 0.000877 | 0.00174 | 0.0155 | 0.00614 |

### Second Embodiment

This disclosure is not limited to the first embodiment described above, and as illustrated in FIG. 18, the thin film 21 may be provided not only on the grating wall surfaces, may be provided over the entire boundary plane continuously. In this case, the grating wall surface portion satisfies the relationship of above-described expression, and the grating surface portion only has to have an anti-reflection function. Since the thin film is formed over the entire boundary plane, the diffraction optical element may be manufactured easily at low costs.

For example, after the diffractive grating 12 has manufactured, the thin film is formed from the grating surfaces to the entire grating wall surfaces by using physical deposition method such as vacuum deposition or a spin coat method, and then the diffractive grating 11 may be formed. However, this disclosure is not limited thereto. Furthermore, by providing the thin film over the entire boundary plane, the adhesiveness between the diffractive grating 11 and the diffractive grating 12 may be improved. The diffractive index and the film thickness of the grating surfaces and the grating wall surfaces may be different from each other, the anti-reflection function of the grating surfaces and the flare reducing function of the grating wall surfaces may be designed arbitrarily according to the method of manufacture.

### Third Embodiment

This disclosure is not limited to the first embodiment (Examples 1 to 6), in which the two diffractive gratings are in closely contact with each other in the optical axis direction, and a configuration in which two diffractive gratings are apart from each other and a different material is provided over the entire boundary plane as illustrated in FIG. 19. In this case, the two diffractive gratings may have different grating heights and two thin films having different thickness, so that the choices of the material that constitute the diffractive gratings or the material of the thin film may be expanded.

### MODIFICATIONS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the above-described thin film is not limited to have a single layer, and may be composed of multiple layers. In the above-described example, the grating pitch is set to 100 μm, it only have to be 80 μm or more.

This application claims the benefit of Japanese Patent Application No. 2013-041781, filed Mar. 4, 2013, which is hereby incorporated by reference herein in its entirety.

What is claimed is:

1. A diffraction optical element comprising:
a diffractive grating provided with a grating surface and a grating wall surface; and
a thin film arranged on the grating wall surface and being transparent with respect to light of a used wavelength range, wherein
the following expressions;
0.05<nfd−ngd<0.5
0.01<(nfd−ngd)*wf/λd<0.05
are satisfied,
where nfd is a refractive index of the thin film with respect to a d line, ngd is a refractive index of a material of the diffractive grating with respect to the d line, wf is a thickness of the thin film, and λd is a wavelength of the d line.

2. The diffraction optical element according to claim 1, wherein the following expression;
0≦kfd−kgd<0.5
is satisfied
where kfd is an extinction coefficient of the thin film with respect to the d line, and kgd is an extinction coefficient of the material of the diffractive grating with respect to the d line.

3. The diffraction optical element according to claim 1, wherein the thin film is continuously provided from the grating wall surface to the grating surface.

4. The diffraction optical element according to claim 1, wherein a designed order is +1st order or −1st order.

5. The diffraction optical element according to claim 1, wherein a grating pitch of the diffractive grating is 80 μm or more.

6. A diffraction optical element comprising:
a first diffractive grating provided with a first grating surface and a first grating wall surface;
a second diffractive grating provided with a second grating surface and a second grating wall surface; and
a thin film arranged between the first grating wall surface and the second grating wall surface and being transparent with respect to light of a used wavelength range, wherein
the following expressions;
nd1<nd2
0.05<nfd−nd2<0.5,
0.01<(nfd−nd2)*wf/λd<0.05
are satisfied,
where nd1 and nd2 are refractive indexes of material of the first diffractive grating and the second diffractive grating with respect to a d line respectively, nfd is a refractive index of the thin film with respect to the d line, wf is a thickness of the thin film, and λd is a wavelength of the d line.

7. The diffraction optical element according to claim 6, wherein the first grating surface and the second grating surface are contact with each other with no space, and the first grating wall surface and the second grating wall surface are joined to each other via the thin film.

8. The diffraction optical element according to claim 6, wherein the following expression;
0≦kfd−kgd<0.5
is satisfied
where kfd is an extinction coefficient of the thin film with respect to the d line, and kgd is an extinction coefficient of the material of the second diffractive grating with respect to the d line.

9. The diffraction optical element according to claim 6, wherein the thin film is continuously provided from the second grating wall surface to the second grating surface.

10. The diffraction optical element according to claim 6, wherein the following expressions;
νd1<25
νd2>35
0.940≦(n12×d1−n11×d2)/(m×λ)≦1.060
are satisfied,
where d1 and d2 are grating heights of the first diffractive grating and the second diffractive grating, νd1 and νd2 are Abbe numbers of the materials of the first diffractive grating and the second diffractive grating, and λ is an arbitrary wavelength in a visible wavelength band.

11. The diffraction optical element according to claim 6, wherein a designed order is +1st order or −1st order.

12. The diffraction optical element according to claim 6, wherein grating pitches of the first diffractive grating and the second diffractive grating are 80 μm or more.

13. An optical system comprising:
a diffraction optical element including:
a diffractive grating provided with a grating surface and a grating wall surface; and
a thin film arranged on the grating wall surface and being transparent with respect to light of a used wavelength range, wherein
the following expressions;
0.05<nfd−ngd<0.5
0.01<(nfd−ngd)*wf/λd<0.05
are satisfied,
where nfd is a refractive index of the thin film with respect to a d line, ngd is a refractive index of a material of the diffractive grating with respect to the d line, wf is a thickness of the thin film, and λd is a wavelength of the d line; and
an aperture arranged on an outgoing side of the diffraction optical element.

14. An optical apparatus comprising the optical system according to claim 13.
